(19) United States
(12) Patent Application Publication
(10) Pub. No.: US 2007/0025045 A1
(43) Pub. Date: Feb. 1, 2007

(54) Demagnetizable electromagnetic door lock

(76) Inventor: Chen-Fei Chang, Taipei (TW)

Correspondence Address: LIN & ASSOCIATES INTELLECTUAL PROPERTY, P.O. BOX 2339, SARATOGA, CA, 95070-0339, US

(21) Appl. No.: 11/193,914

(22) Filed: Jul. 29, 2005

(51) Int. Cl. H01H 47/00

(52) U.S. Cl. 361/143

(57) ABSTRACT

A demagnetizable electromagnetic door lock is actuated by generating or degenerating magnetic force of an electromagnetic coil. A magnetic field direction driving circuit is electrically connected to the electromagnetic coil. Under the control of a controller, after the magnetic field direction driving circuit is applied to eliminate the residual magnetic force of the electromagnetic coil, the door lock can work smoothly in due course.

### BACKGROUND OF THE INVENTION

1. Field of the Invention

The present invention relates generally to an electromagnetic door lock, and more particularly to a demagnetizable electromagnetic door lock, which provides with a magnetic field direction driving circuit to eliminate residual magnetization of an electromagnetic coil.

2. The Prior Arts

A conventional electromagnetic door lock applies an electromagnetic driving manner to open/close a door lock. Its executing mechanism may be classified as two groups: an electromagnetic coil type and a DC motor type. These two types of executing mechanism can reverse the motion direction of a lock member by means of changing its DC polarity, and thereby perform a door lock open/close operation.

However, in an operation of this conventional electromagnetic door lock, a hysteresis phenomenon might appear in a silicon steel core coupling with the electromagnetic coil and thus results in a failure of opening/closing the door lock. It could be an awful experience if no substitutive key is available on hand.

Silicon steel sheet is rather expensive, so iron block is often used for substituting silicon steel sheet as a core. However, the substitution of the iron block undoubtedly worsens the hysteresis loop. This forms a motivation of the present invention.

### SUMMARY OF THE INVENTION

The primary objective of the present invention is to provide a demagnetizable electromagnetic door lock, which can overcome the problem of residual magnetization of the electromagnetic coil and can thus be smoothly opened/closed.

In order to realize the objective above, a demagnetizable electromagnetic door lock in accordance with the present invention is actuated by generating or degenerating magnetic force of an electromagnetic coil and comprises a magnetic field direction driving circuit electrically connected to the electromagnetic coil. Under the control of a controller, after the magnetic field direction driving circuit is applied to eliminate the residual magnetic force of the electromagnetic coil, the door lock can work smoothly in due course.

For more detailed information regarding advantages or features of the present invention, at least one example of preferred embodiment will be described below with reference to the annexed drawings.

### BRIEF DESCRIPTION OF THE DRAWINGS

The related drawings in connection with the detailed description of the present invention to be made later are described briefly as follows, wherein:

FIG. 1 is a schematic view of a demagnetizable electromagnetic door lock in accordance with the present invention; and

FIG. 2 is a schematic view of a circuitry of the demagnetizable electromagnetic door lock of the present invention.

### DETAILED DESCRIPTION OF THE PREFERRED EMBODIMENT

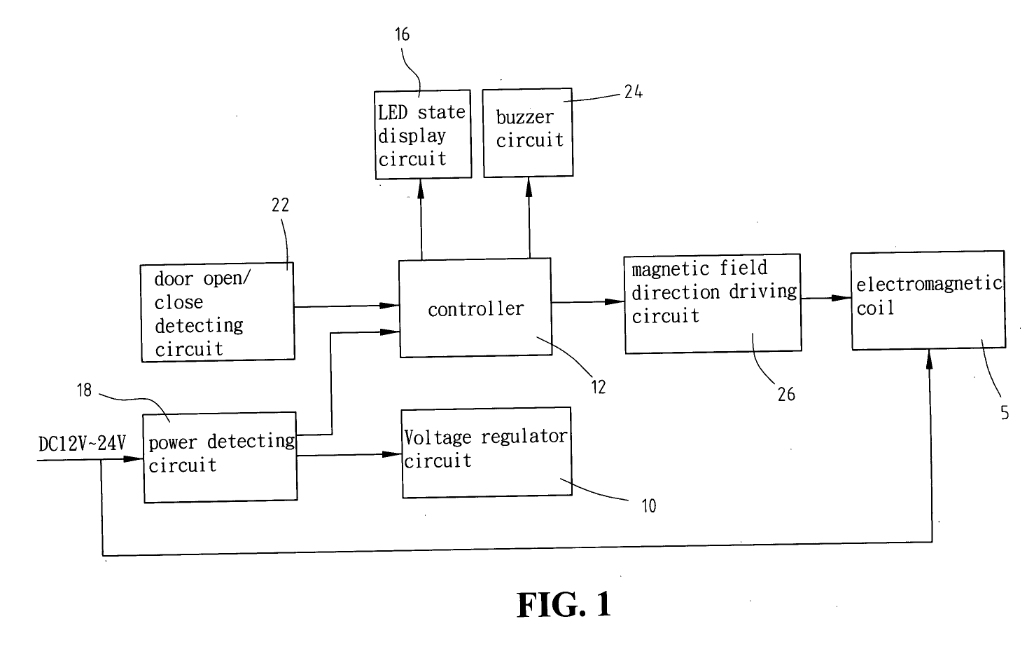

Referring to FIG. 1, a demagnetizable electromagnetic door lock in accordance with the present invention is provided with a magnetic field direction driving circuit 26 electrically connected to an electromagnetic coil 5. First the operation of a conventional electromagnetic door lock is described, and then a role of the magnetic field direction driving circuit 26 played in the demagnetizable electromagnetic door lock of the present invention is illustrated.

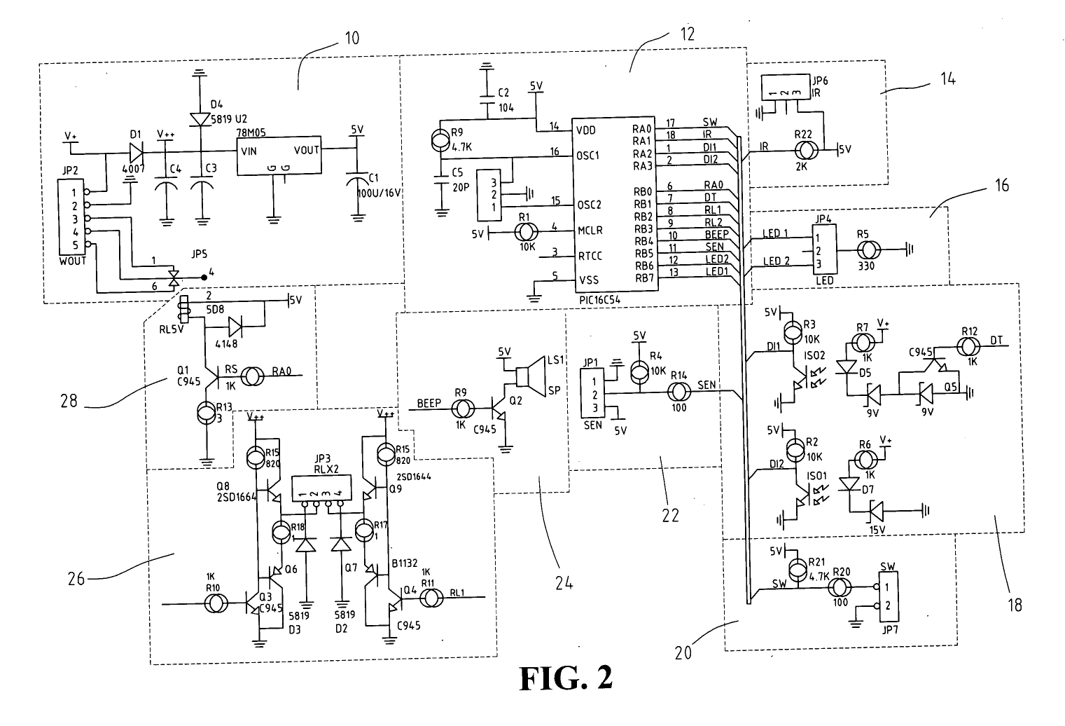

When a controller 12 connected with a power detecting circuit 18 and a voltage regulator circuit 10 is ready for work and receives a command from an external control signal circuit 14 (refer to FIG. 2) for opening or closing the door lock, the controller 12 actuates the door lock to be opened or closed and simultaneously starts a buzzer circuit 24 and an LED state display circuit 16 according to magnetization or demagnetization of the electromagnetic coil 5.

In order to solve the hysteresis phenomenon of the electromagnetic coil 5, the magnetic field direction driving circuit 26 is provided to eliminate the residual magnetization of the electromagnetic coil 5 so that the controller 12 enables the door lock to work smoothly. Furthermore, a door open/close detecting circuit 22, such as Hall IC, is provided to detect the state of the door so that the controller 12 enables the electromagnetic coil 5 to be demagnetized when desired.

As already known when there are magnetic lines of force passing through the door open/close detecting circuit 22 (Hall IC), it would generate a signal of short circuit at a pin thereof. Such a Hall IC is properly arranged on an iron core (not shown) of the electromagnetic coil 5. When the electromagnetic coil 5 conducts electricity, if an iron plate opposite is not approaching the electromagnetic coil 5, the magnetic lines of force are noncompact and cannot start the Hall IC, and thereby, an open state of the electromagnetic door lock can thus be detected; on the contrary, if the iron plate opposite is tightly attached to the electromagnetic coil 5, a close state of the door lock would be sensed by means of a short circuit of the Hall IC.

Referring to FIG. 2, once the door open/close detecting circuit 22 provides with the state of the door open/close, an instantaneous inverse control signal will be applied to RL1 and RL2 of the magnetic field direction driving circuit 26 so as to make the electromagnetic coil 5 generate an inverse magnetic field to eliminate the residual magnetic force and thus make the door be pushed and opened easily.

Moreover, with the exception of the controller 12, the rest elements or devices, such as the voltage regulator circuit 10, the external control signal circuit 14, the LED state display circuit 16, the power detecting circuit 18, the door open/close detecting circuit 22 of Hall IC, the buzzer circuit 24, the magnetic field direction driving circuit 26, a coercive door-open switch 20, and an external alarm output circuit 28, all are already known elements or devices that need herein no more reiterations.

In the description above, at least one preferred embodiment has been described in detail with reference to the drawings annexed, and it is apparent that numerous changes or modifications may be made without departing from the true spirit and scope thereof, as set forth in the claims below.

1. A demagnetizable electromagnetic door lock, actuated by generating or degenerating magnetic force of an electromagnetic coil, and the improvement comprising a magnetic field direction driving circuit electrically connected to the electromagnetic coil.

2. The demagnetizable electromagnetic door lock as claimed in claim 1 further comprising a controller for smoothly controlling the door lock through the magnetic field direction driving circuit that is applied to eliminate the residual magnetic force of the electromagnetic coil.

3. The demagnetizable electromagnetic door lock as claimed in claim 2 further comprising a door open/close detecting circuit capable of sensing the state of the door lock and providing the same to the controller.

4. The demagnetizable electromagnetic door lock as claimed in claim 3, wherein the door open/close detecting circuit is generally a Hall IC.
